(19) United States
(12) Patent Application Publication
(10) Pub. No.: US 2008/0162650 A1
(43) Pub. Date: Jul. 3, 2008

(54) USER-CHOSEN MEDIA CONTENT

(76) Inventors: Jonathan William MEDVED, Jerusalem (IL); David Elliot Goldfarb, Bet Shemesh (IL); Lawrence Joel Reisler, Bet Shemesh (IL)

Correspondence Address: DANIEL J SWIRSKY, 55 REUVEN ST., BEIT SHEMESH, 99544, omitted

(21) Appl. No.: 11/768,989

(22) Filed: Jun. 27, 2007

Related U.S. Application Data
(60) Provisional application No. 60/816,888, filed on Jun. 28, 2006.
(60) Provisional application No. 60/829,896, filed on Oct. 18, 2006.

(51) Int. Cl. G06F 15/16

(52) U.S. Cl. 709/206

(57) ABSTRACT

A method includes sending a user-chosen media clip to a device of a buddy of the user, the clip to be played upon a triggering event not controlled by the buddy.

### CROSS-REFERENCE TO RELATED APPLICATIONS

This application claims benefit from U.S. Provisional Patent Application No. 60/816,888, filed Jun. 28, 2006, and U.S. Provisional Patent Application No. 60/829,896, filed Oct. 18, 2006, which are hereby incorporated in their entirety by reference.

### FIELD OF THE INVENTION

The present invention relates to cellular telephones generally and to the generation of shared personalization content in particular.

### BACKGROUND OF THE INVENTION

A ringtone is a sound played on a phone handset, e.g. on a mobile cellular phone, to announce an incoming phone call. A ringtone is typically selected by the user of the phone receiving the call. A ringback tone is a sound played on a phone handset when calling another phone. Typically, the tone is chosen by the owner of the dialed phone.

A video ringtone or video ringback tone is similar, but uses a video clip rather than an audio sound.

FIG. 1, to which reference is now made, illustrates a media content sharing system 100 described in prior patent applications U.S. 60/771,883 and 60/772,564, now incorporated into U.S. patent application Ser. No. 11/544,938 and assigned to the common assignee of the present application. When the content is video ringtones, the video ringtone chosen by the calling party is displayed on the called handset.

FIG. 1 shows a communication device 110, owned by, for example, Jack, and a telephone 120, owned by, for example, Jill, who are setting up or using a voice connection 140 for a telephone conversation. Jack and Jill are members of a content sharing community 150 and use a community server 130 for the selection and download of content, such as media clips, to be played on communication device 110. In the example, Jack and Jill are also “buddies”, members of community 150 who elect to share content with each other.

Community server 130 comprises a media clip selection database 132 which stores a collection of media clips 134 for selection by members of community 150. Jill accesses community server 130 via an Internet connection (arrow 131) and then selects a media clip 134 for her video ringtone.

A software client (not shown) on Jack's communication device 110 then downloads (arrow 133) Jill's media clip 134 to device 110. Communication device 110 comprises a media player 112, a personalization content manager 137, and buddy media clip database 138. Buddy media clip database 138 comprises media clips 136 which are copied, and possibly transcoded, versions of media clips 134 selected by Jack's buddies.

When Jill initiates a voice connection 140 from telephone 120 to Jack's communication device 110, personalization content manager 137 identifies her as one of Jack's buddies. Personalization content manager 137 then retrieves the media clip 136 originally selected by Jill and plays it as a video ringtone on media player 112, thus playing Jill's selected clip on Jack's phone when Jill calls.

Community 150 is also used in a similar manner to download other variations of video ringtones. For example, Jill can select a media clip 134 for a video ringback tone as well. After the selected media clip 134 is downloaded to Jack's device 110, it can be played as a video ringback tone when he calls Jill. Patent applications 60/771,883 and 60/772,564 also describe how community 150 can be used in a similar manner to select and distribute “ringbye” tones which are played at the end of a phone conversation.

### SUMMARY OF THE PRESENT INVENTION

There is provided, in accordance with a preferred embodiment of the present invention, a method including sending a user-chosen media clip to a device of a buddy of the user, the clip to be played upon a triggering event not controlled by the buddy.

Additionally, in accordance with a preferred embodiment of the present invention, the sending includes uploading the media clip to a community server. The uploading may also include providing an indication of ownership of the clip and/or an indication of at least one buddy to distribute the media clip.

Moreover, in accordance with a preferred embodiment of the present invention, the device is a mobile device.

Further, in accordance with a preferred embodiment of the present invention, the triggering event may be a call-related event. For example, the call-related event may be one of the following events: an incoming call, an outgoing call, the end of a call, call waiting, and call busy.

Still further, in accordance with a preferred embodiment of the present invention, the user-chosen clip is available only to buddies of the user.

Additionally, in accordance with a preferred embodiment of the present invention, the clip may be uploaded from a video camera, a personal computer, a mobile device or a website.

Moreover, in accordance with a preferred embodiment of the present invention, the clip may be a video clip, an audio clip, a slide show, a presentation, an animation, or a still picture.

Further, in accordance with a preferred embodiment of the present invention, the clip may be a customized combination of clips. For example, the customized combination of clips may have multiple layers. These layers may include at least two of the following layers: a music layer, a video layer, a prefix clip, a suffix clip, a voice overlay, a music overlay, a text overlay and special effects.

Still further, the customized combination may include at least an original clip and at least one of the following additions: an audio track, a video track, and a special effect. Alternatively, the customized combination may include at least a portion of an original clip and at least one of the following replacements of the original tracks: an audio track and a video track.

Still further, the method may include separately storing the layers and providing merge instructions to the device for merging upon the triggering event.

Additionally, in accordance with a preferred embodiment of the present invention, the sending includes sending textual instructions to a server. These may be in the form of an email.

Further, in accordance with a preferred embodiment of the present invention, the email may have an email address associated with the user.

Still further, in accordance with a preferred embodiment of the present invention, the email may include information in a header which uniquely identifies the user.

There is also provided, in accordance with a preferred embodiment of the present invention, a method including receiving a buddy-chosen media clip from a server and playing the buddy-chosen clip upon a triggering event associated with the buddy.

Additionally, the triggering event may be a call-related event, such as is described hereinabove.

Finally, there is provided, a system including a receiver to receive a user-chosen media clip from a user, a community server to store at least the user-chosen clips and a downloader to provide at least the user-chosen clips to at least one mobile devices of at least one of the user's buddies as shared personalization content.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a media content sharing system for the selection and distribution of media content, such as video ringtones;

FIGS. 2A, 2B and 2C are schematic illustrations of three media generation and upload systems, constructed and operative in accordance with the present invention;

FIG. 3 is a flow chart illustrating the flow of control between the various entities included in the systems of FIG. 2; and

FIGS. 4A and 4B are schematic illustrations of how an existing media clip may be customized.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The present invention may be a novel system and method enabling users to choose personalization content to be shared with other users, in the form of media clips, which, in accordance with a preferred embodiment of the present invention, may be any type of visual and/or aural media, such as images, videos, animations, slide shows, etc., audio signals or combinations thereof. The user may create and/or edit the content by themselves or they may select or combine content from other sources. The present invention may provide a distribution method for such personalization content

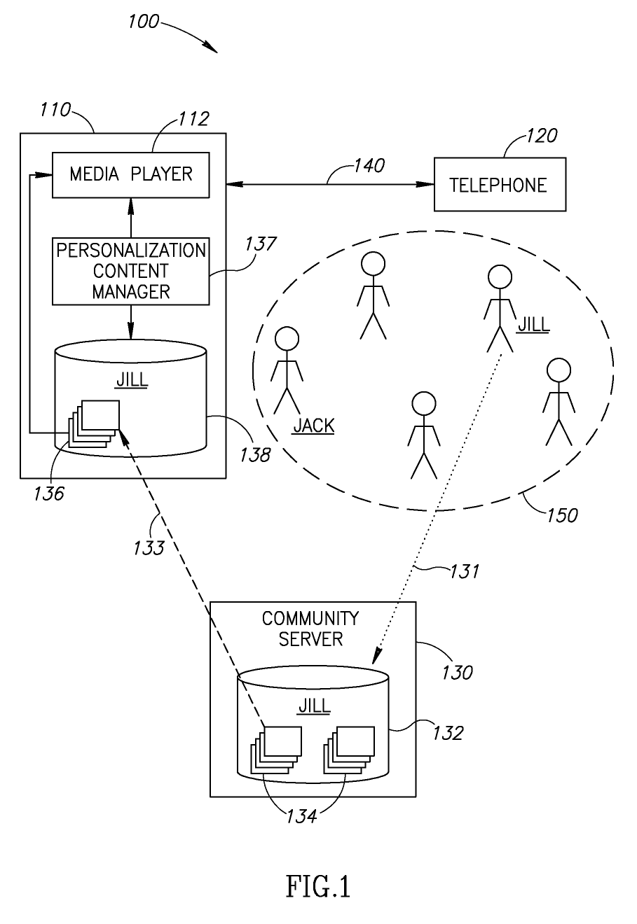

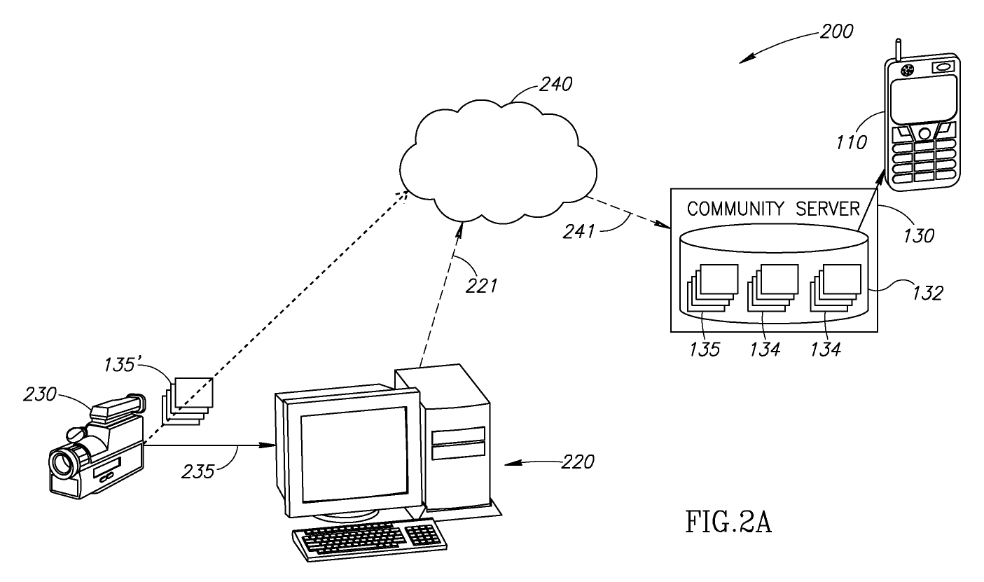

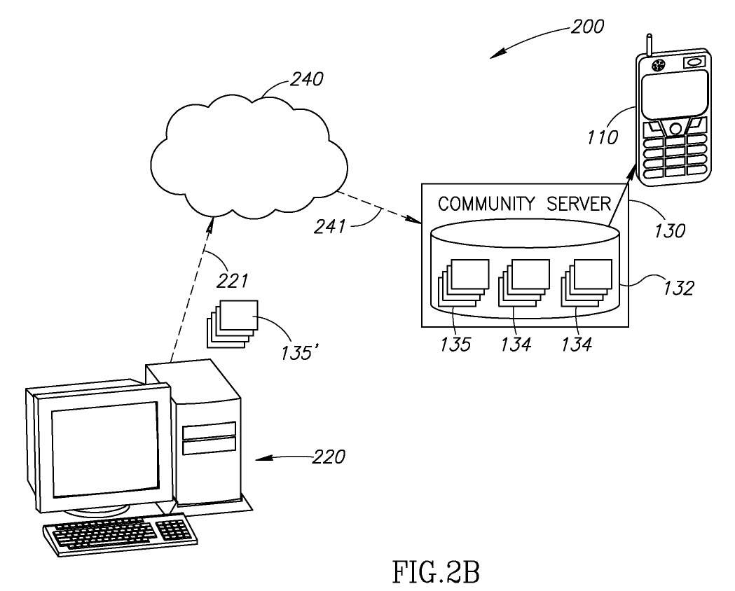

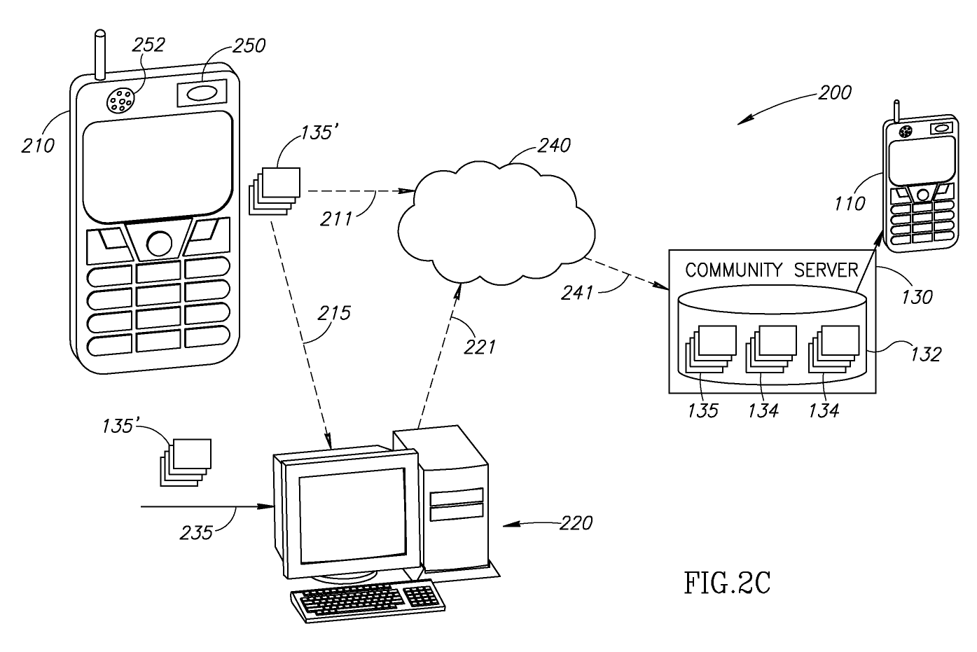

FIGS. 2A, 2B and 2C, to which reference is now made, illustrates three forms of a novel system 200 for the generation and upload of media clips to be shared with other users, such as members of community 150 (FIG. 1). Typically, the media clips may be used as call-related video tones, such a ringtone, a ringback tone, a ringbye tone, and/or when the call cannot be completed (busy or call-waiting). The media clips may also just be downloaded for the other users, who typically are buddies of the person generating the clips, to view at their own initiative.

In FIG. 2A, system 200 may comprise a personal computer 220, a video camera 230, and a community server 130. A communications network 240 may be used to exchange data between personal computer 220 and community server 130. Communications network 240 may be, for example, the Internet or any other suitable network.

As in the prior art, community server 130 may comprise media clip selection database 132 with system-provided media clips 134. However, in addition to system media clips 134, it may also store user-chosen media clips 135 that have been uploaded by individual members of community 150 (FIG. 1).

A member of community 150, for example, Jill, may use video camera 230 to generate an individual media clip 135′. Individual media clip 135′ may then be uploaded (arrow 235) to personal computer 220. The connection between video camera 230 and personal computer 220 may be any suitable data connection, including, for example, a USB cable or a Bluetooth wireless connection. Alternatively, video camera 230 may be directly connected to a network server.

Jill may then upload individual media clip 135′ to communication network 240 (arrow 221) and from there to community server 130 (arrow 241), where it may become user-chosen media clip 135. User-chosen media clip 135 may then be stored in media clip selection database 132 with an indication that it was uploaded by Jill.

It will be appreciated that, once user-chosen media clip 135 has been stored in media clip selection database 132, it may be available to Jill in the same manner as system-provided media clips 134. Jill may select media clip 135 as shared personalization content, for one or more of several possible call-related tones for her buddies, including, for example, as a video ringtone, a video ringback tone, a video ringbye tone, etc., or as a reference in or attachment to an SMS or an MMS. Such tones may occur upon any of a plurality of triggering events related to her buddies, such as call initiation, call ringing, end of call, a busy signal, a “fast busy” signal, or a call waiting signal. Other types of triggering events, which may be associated with her buddies, may also be possible and are incorporated in the present invention.

At some point, after Jill selects media clip 135 for her buddy, e.g., Jack, community server 130 may download media clip 135 to her buddy's device, such as Jack's device 110. The downloaded may proceed as discussed in U.S. Ser. No. 11/544,938.

In another embodiment, shown in FIG. 2B, individual media clip 135′ may be content which the user may have selected or received from another source, such as a website, or generated from an application which may produce media content. The user may upload individual media clip 135′ from personal computer 220, as per arrow 221. The remaining method may be the same as described for user clip 135.

In an alternative preferred embodiment of the present invention, shown in FIG. 2C, a built-in camera on a communications device 210 may also be used to record individual media clip 135′. In this and in the previous embodiments, personalization content 135′ may be a video clip or an audio clip.

Communications device 210 may be a smart phone equipped with a built-in video camera 250 and a microphone 252 and may also be capable of creating a wireless data connection with communications network 240.

The user of device 210, for example, Jill, may use camera 250 or microphone 252 to record individual media clip 135′, where camera 250, together with microphone 252, may produce a media clip, and microphone 252, operating by itself, may record an audio clip. As in FIG. 2, individual media clip 135′ may then be uploaded to network 240 (arrow 211), and from there to community server 130 (arrow 241).

In another alternative preferred embodiment of the present invention, individual media clips 135′ may not be uploaded directly from communications device 210. Instead, they may first be uploaded (arrow 215) to personal computer 220. Any suitable device may be used to upload individual media clip 135′ to personal computer 220, including, for example, Bluetooth, infrared, WiFi, WiMax, or a cable. Once uploaded to personal computer 220, individual clip 135′ may then be transmitted, as in the previous embodiments, to community server 130 and added to database 132 as clips 135.

It will be appreciated that once individual media clip 135′ has been added to database 132 as user-chosen media clip 135, it may be available for distribution in the same manner as system-provided media clips 134. However, user-chosen media clips 135 may only be available for distribution to the buddies of the community member that uploaded the clip. For example, if user-chosen media clip 135 was generated by Jill, then it may be downloaded only to devices 110 of Jill's buddies. User-chosen media clip 135 may not be available to other members of community 150 (FIG. 1).

In another embodiment, users may upload their individual clips 135′ via email. In this embodiment, each user may be assigned a unique email address. For example, the assigned email address might be username@vringo.mobi, where username is the username that the user chose during his/her registration into community 150.

The user may capture or create a new clip 135′ and may select it by emailing it to his/her assigned email address. Community server 130 may harvest email messages that come to such accounts, and may process the attached clips 135′ as user-chosen clips 135.

In a further embodiment, all users may send their individual clips 135′ to a standard address (e.g. share@vringo.mobi). For this embodiment, community server 130 may uniquely identify each user from the return address of his email or from other identifying information in the email headers.

Furthermore, since most cellphones implement video or audio uploads as attachments to emails, a user may embed simple text messages within the upload message and the text messages may act as instructions to community server 130, in a listserv-like manner. For example:

SENDTOjim

ADDTO mylist1

SENDTO harry AT 3 pm

Etc.

The server, when it receives such messages, may process and act upon the included instructions.

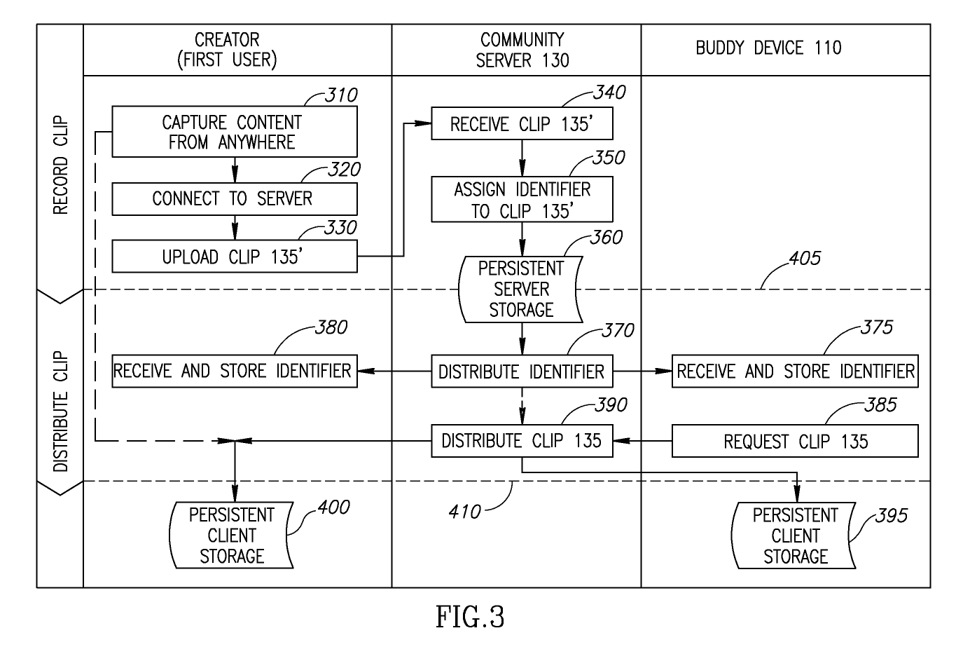

FIG. 3, to which reference is also made, may illustrate the flow of control from entity to entity as clips 135 are generated and distributed. The first column lists steps performed by the creator of a clip 135′; the second column lists steps executed on community server 130; and the third column lists steps on the communication devices 110 of the creator's buddies. Dotted lines 405 and 410 demark the phases in the generation and distribution of video ringtones. The steps above line 405 relate to generation; the steps between lines 405 and 410 relate to distribution; and the steps below line 410 relate to an operative state when the call-related tones may be played.

Generation may begin with the creator, for example, Jill, capturing (step 310) her individual media clip 135′. This may refer to any of the embodiments discussed hereinabove, including generating it, purchasing it from a third party source or generating it by a computerized application. It may also be a slide show, e.g., an animated .GIF file, a still picture, a silent video or any other form of presentation or media.

The user may connect (step 320) to community server 130 via any suitable method. Individual clip 135′ may then be uploaded (step 330) via, for example, an Internet connection, via any of the upload operations discussed hereinabove. This upload may be done by HTTP or TCP protocols on a new or existing connection, or any other suitable network communication protocol. If media clip 135′ was generated on Jill's device 210, then clip 135′ may remain on Jill's device, as indicated by arrow 331, in persistent client storage 400.

As shown in FIG. 3, control may then pass to community server 130 which may receive (step 340) individual clip 135′ as user-chosen clip 135. Server 130 may then assign (step 350) a Uniform Resource Locator (URL) or other identifier to user-chosen clip 135 as per the conventions for system-provided media clips 134 stored in clip selection database 132. User-chosen clip 135 may then be stored (step 360) in database 132 with an indication that it has been selected by Jill. As indicated by line 405, the generation process is complete at this stage.

Community server may then distribute (step 370) the identifier for user-chosen clip 135 to Jill and her buddies, for example, Jack. The identifier may be received and stored (step 380) on one or more devices 210 belonging to Jill. The identifier may remain (step 400) in persistent client storage on Jill's device(s) 210 to enable her to download clip 135 at a later date if she so desires.

In parallel, Jack's communication device 210 may also receive and store (step 375) the identifier, and may request (step 385) user-chosen clip 135 for download from community server 130. Community server 130 may then download (step 390) user-chosen clip 135 to Jack's device 210, where it is stored (step 395) until needed as a video or audio call-related tone.

In the operative state, as defined by line 410, communication devices 210, belonging to Jill's buddies, may play the shared personalization content that she generated at the appropriate time. For example, Jack's device 110 may play user-chosen clip 135 whenever Jill calls his communication device 110 or he calls Jill's device. It will be appreciated that Jill may utilize user-chosen clip 135 for any of the media forms enabled by system 100. This may include ringtones, ringback tones, ringbye tones, etc.

It will be appreciated that a media clip may be considered to have multiple “layers” to it, some the original creation, others created by the user and still others created by the community server. These layers include the music layer, the video layer, prefixes or suffixes (i.e. music and/or video which comes before or after a selected media clip), voice overlays, music overlays, text overlays, special effects (flashing, vibrating the phone), etc. In another alternative preferred embodiment of the present invention, a user may customize an existing clip by editing and/or adding such layers.

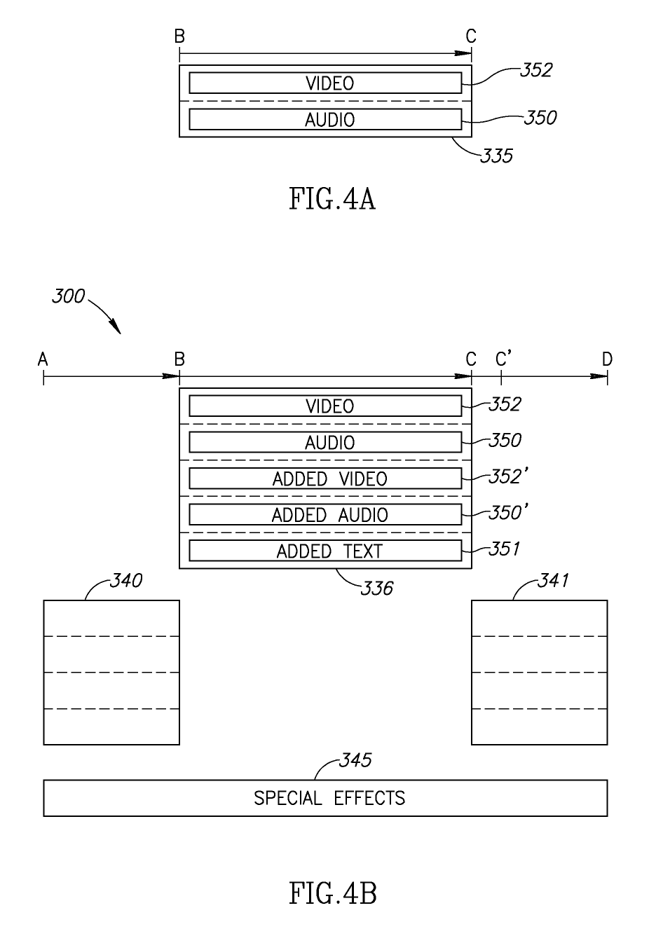

FIGS. 4A and 4B, to which reference is now made, illustrate how, for example, an existing media clip, here labeled 335, may be customized to provide a richer, more personalized experience. Media clip 335 may be any of the media clips described hereinabove.

FIG. 4A shows a time elapsed view of a typical shared personalization content experience as discussed hereinabove in the context of the previous embodiments. Media clip 335 may play from frame B to frame C of the clip on a user's device. Clip 335 may typically comprise a video track 352 and an audio track 350 which may play in parallel for all, or part, of the time between frames B and C.

FIG. 4B shows a customized media clip 336 as part of a multi-layered shared personalization content triggered event 300. An extended timeline for event 300 may run from frame A to frame D. A prefix clip 340 may play prior to customized clip 336, and a suffix clip 341 may play subsequently. Special effects 345 may be invoked at any time from frame A to frame D.

Customized clip 336 may be a customized version of media clip 335, comprising video track 352 and audio track 350. However, clip 336 may also comprise an added video track 352′, an added audio track 350′ and an added text 351.

A user may create customized media clip 336 by replacing the existing audio track 350 of media clip 335 with an added audio track 350′ comprising a personal rendition, e.g. of a song. Similarly, a user may personalize media clip 335 by replacing video track 352 with added video track 352′.

Instead of replacing elements of media clip 134, a user may also add additional tracks as well. For example, added audio track 350′ may comprise a “voice over” or harmony to be played in parallel to audio track 350. A user may also leave all of the original elements of the original video track 352 intact, but add an added video track 352′ to be played in a split screen or superimposed on the original video track 352. Added text 351 may similarly be displayed as a caption superimposed on top of either video track 352 or added video track 352′.

It will be appreciated that clip 336 may comprise multiple added tracks 350′ and 352′, each of which may replace or play in parallel to tracks 350 and 352 respectively. Additional added tracks 350′ and 352′ may also be inserted to extend the playing time of customized clip 336 in such manner that it may play for a longer time than the original media clip 335. For example, if exemplary clip 335 played from frame B to frame C, its customized version (clip 336) may play from frame B to frame C′.

Multiple added texts 351 may also be displayed in addition to, or instead of, video tracks 350 and 350′, and may also be used to extend the playing time of customized clip 336 beyond that of the original media clip 335.

It will be appreciated that the use of one or more added texts 351, tracks 350′ and tracks 352′ is optional; customized media clip 336 may comprise some, none, or all of these features.

A user may generate customized media clip 336 for community server 130, using a tool similar to Windows Movie Maker, commercially available from Microsoft Corporation of the United States. The user may combine any of the tracks, some of which he may select from community server 130 and others he may have uploaded to community server 130, to create new media clip 336. The user may also generate customized media clip 336 on a communications device 110 or on a personal computer, using a similar combination of tracks, after which, the user may upload media clip 336, as described hereinabove. The user may then associate media clip 336 with various triggering events for his various buddies.

In accordance with a preferred embodiment of the present invention, a user may also select a prefix clip 340 to be played immediately prior to customized clip 336, for example, from frame A to frame B. A prefix clip 340 may be any suitable media clip. The user may also select a suffix clip 341 to be played immediately after customized clip 336 from frame C to frame D. A suffix clip 341 may be any suitable media clip. In accordance with another embodiment of the present invention, a media clip may also be injected into the middle of customized clip 336.

A user may also select a special effect 345 to be executed at any time during the course of shared personalization content event 300. For example, an internal command on communications device 210 (FIG. 2C) may be executed to vibrate device 110 at frame A. Similarly, another internal command may be used to flash the screen at frame D. It will be appreciated that the options available for special effects may be defined according to the capabilities of a given device 210.

In accordance with an alternative preferred embodiment of the present invention, customized media clips 336 may not be generated and stored for use during a triggering event. Instead, copies of the relevant elements, such as original clip 335, added tracks 350′ and 352′, added text 351, prefix clip 340 and/or suffix clip 341 maybe stored on communication device 110. These elements may then be merged as necessary and played on the occasion of a triggering event. Such a merger may simply be a matter of indicating to communication device 210 which item is the video track of the media clip and which is the audio track. It will be appreciated however, that the options available for such runtime merging may be defined according to the capabilities of a given device 110.

In accordance with another alternative embodiment of the present invention, a user may want to overlay a short audio track, to an already existing clip 134, 135 or 336. Such an overlay may be previously prepared and cached on communication device 110, waiting for a signal to merge it with the already selected, and already cached, clip 134, 135 or 336. Such a signal may be a particular SMS, IM or SIP message, or via the existing asynchronous data channel between community server 130 and communications device 110. The handset may include an application which may read such messages and may activate the overlaying program when the particular message is received.

The short audio track may also be stored on the community server. For communication devices 110 with simultaneous voice and data channels, community server 130 may transmit the short audio track to a buddy, who the user is currently calling, upon receipt of a flag from the sending user's communication device 110.

It will be appreciated that the embodiments described hereinabove may include a new preferred method for the delivery and receipt of user generated media content between members of a community 150 served by a community server 130. Members of community 150 may use the present invention as a delivery system not only to deliver user generated and user modified content to their buddies but to play it to them as well, without any action on the part of the buddy. The media content may play upon receipt of a triggering event from or related to the user.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
sending a user-chosen media clip to a device of a buddy of said user, said clip to be played upon a triggering event not controlled by the buddy.

2. The method according to claim 1 and wherein said sending comprises uploading said media clip to a community server.

3. The method according to claim 2 and wherein said uploading comprises providing an indication of ownership of said clip.

4. The method according to claim 2 and wherein said uploading comprises providing an indication of at least one buddy to distribute said media clip.

5. The method according to claim 1 and wherein said device is a mobile device.

6. The method according to claim 3 and wherein said user-chosen clip is available only to buddies of said user.

7. The method according to claim 2 and wherein said clip is uploaded from a video camera.

8. The method according to claim 2 and wherein said clip is uploaded from a personal computer.

9. The method according to claim 2 and wherein said clip is uploaded from a mobile device.

10. The method according to claim 2 and wherein said clip is generated from a website.

11. The method according to claim 1 and wherein said triggering event is a call-related event.

12. The method according to claim 11 and wherein said call-related event is one of the following call-related events: an incoming call, an outgoing call, the end of a call, call waiting and call busy.

13. The method according to claim 1 and wherein said clip is one of the following types of clips: a video clip, an audio clip, a slide show, a presentation, an animation, and a still picture.

14. The method according to claim 1 and wherein said clip is a customized combination of clips.

15. The method according to claim 14 and wherein said customized combination of clips has multiple layers.

16. The method according to claim 15 and wherein said layers comprise at least two of the following layers: a music layer, a video layer, a prefix clip, a suffix clip, a voice overlay, a music overlay, a text overlay and special effects.

17. The method according to claim 15 and comprising separately storing said layers and providing merge instructions to said device for merging upon said triggering event.

18. The method according to claim 17 and comprising creating at least one of said layers at the time of or in response to said triggering event.

19. The method according to claim 15 and wherein said customized combination includes at least an original clip and at least one of the following additions: an audio track, a video track, and a special effect.

20. The method according to claim 15 and wherein said customized combination includes at least a portion of an original clip and at least one of the following replacements of the original tracks: an audio track and a video track.

21. The method according to claim 1 and wherein said sending comprises sending textual instructions to a server.

22. The method according to claim 21 and wherein said instructions are in the form of an email.

23. The method according to claim 21 and wherein said email has an email address associated with said user.

24. The method according to claim 22 and wherein said email comprises information in a header which uniquely identifies said user.

25. A method comprising:
receiving a buddy-chosen media clip from a server; and
playing said buddy-chosen clip upon a triggering event associated with said buddy.

26. The method according to claim 25 and wherein said triggering event is a call-related event.

27. The method according to claim 26 and wherein said call-related event is one of the following call-related events: an incoming call, an outgoing call, the end of a call, call waiting and call busy.

28. The method according to claim 25 and wherein said clip is a customized combination of clips.

29. The method according to claim 28 and wherein said customized combination of clips has multiple layers.

30. The method according to claim 29 and wherein said layers comprise at least two of the following layers: a music layer, a video layer, a prefix clip, a suffix clip, a voice overlay, a music overlay, a text overlay and special effects.

31. The method according to claim 29 and comprising separately storing said layers and providing merge instructions to said device for merging upon said triggering event.

32. The method according to claim 31 and comprising creating at least one of said layers at the time of or in response to said triggering event.

33. A system comprising:
a receiver to receive a user-chosen media clip from a user;
a community server to store at least said user-chosen clips; and
a downloader to provide at least said user-chosen clips to at least one device of at least one of said user's buddies as shared personalization content.

34. The system according to claim 33 and wherein said server comprises means to store an indication of ownership of said clip.

35. The system according to claim 33 and wherein said server comprises means to store an indication of at least one buddy to distribute said media clip.

36. The system according to claim 33 and wherein said device is mobile device.

37. The system according to claim 34 and wherein said server comprises means to provide said user-chosen clip only to buddies of said user.

38. The system according to claim 33 and wherein said triggering event is a call-related event.

39. The system according to claim 38 and wherein said call-related event is one of the following call-related events: an incoming call, an outgoing call, the end of a call, call waiting and call busy.

40. The system according to claim 33 and wherein said clip is one of the following types of clips: a video clip, an audio clip, a slide show, a presentation, an animation, and a still picture.

41. The system according to claim 33 and wherein said clip is a customized combination of clips.

42. The system according to claim 41 and wherein said customized combination of clips has multiple layers.

43. The system according to claim 42 and wherein said layers comprise at least two of the following layers: a music layer, a video layer, a prefix clip, a suffix clip, a voice overlay, a music overlay, a text overlay and special effects.

44. The system according to claim 42 and wherein said downloader comprises means to provide merge instructions to said device for merging said layers upon said triggering event.

45. The system according to claim 42 and wherein said customized combination includes at least an original clip and at least one of the following additions: an audio track, a video track, and a special effect.

46. The system according to claim 42 and wherein said customized combination includes at least a portion of an original clip and at least one of the following replacements of the original tracks: an audio track and a video track.

47. The system according to claim 33 and also comprising a text instruction parser to parse textual instructions from said user.

48. The system according to claim 47 and wherein said instructions are in the form of an email.

49. The system according to claim 47 and wherein said email has an email address associated with said user.

50. The system according to claim 48 and wherein said email comprises information in a header which uniquely identifies said user.
